(19) United States
(12) Patent Application Publication
(10) Pub. No.: US 2010/0296504 A1
(43) Pub. Date: Nov. 25, 2010

(54) METHOD, SYSTEM AND TERMINAL FOR SCHEDULING SYSTEM INFORMATION

(75) Inventors: Zuoyan ZHU, Shenzhen (CN); Mingjiang XIE, Shenzhen (CN); Xiaofei MA, Shenzhen (CN)

Correspondence Address: Huawei Technologies Co., Ltd., IPR Dept., Building B1-3-A,, Huawei Industrial Base, Bantian, Shenzhen Guangdong, 518129, CN

(73) Assignee: HUAWEI TECHNOLOGIES CO., LTD., Shenzhen (CN)

(21) Appl. No.: 12/849,219

(22) Filed: Aug. 3, 2010

Related U.S. Application Data
(63) Continuation of application No. PCT/CN2009/070049, filed on Jan. 6, 2009.

(30) Foreign Application Priority Data
Feb. 3, 2008 (CN) 200810065298.9

(51) Int. Cl. H04J 3/00

(52) U.S. Cl. 370/345

(57) ABSTRACT

Scheduling System Information (SI) in a radio communication system is disclosed. System Frame Number (SFN) and position of System Information is determined in accordance with the SFN. The SI-x is established, and all SIs on the radio frames are distributed discretely at different times for sending. An SI scheduling system and a UE are also disclosed. The technical solution under the present invention optimizes scheduling of SI, avoids excessive network load caused by sequentially sending of all SIs on different sub-frames, and improves the efficiency of scheduling user data.

### CROSS-REFERENCE TO RELATED APPLICATIONS

This application is a continuation of International Application No. PCT/CN2009/070049, filed on Jan. 6, 2009, which claims priority to Chinese Patent Application No. 200810065298.9, filed on Feb. 3, 2008, both of which are hereby incorporated by reference in their entireties.

### FIELD OF THE INVENTION

The present invention relates to a radio communication system, and in particular, to an information scheduling technology in a radio communication system.

### BACKGROUND

With the development of communication technology, people pay more and more attention to improving the spectrum utilization ratio of the communication system, providing higher user data rates, improving the system capacity and coverage, and reducing the operation costs.

In a cellular mobile communication system, a network is divided into several cells. Different cell configuration attributes are configured for different cells according to the actual conditions. In order to improve the efficiency of transmitting the configuration attribute information on the network, such information is generally transmitted through broadcast in various mobile communication systems. Specifically, a broadcast channel is added into each cell, and the System Information (SI), inclusive of the cell configuration attribute information, is broadcast periodically through the broadcast channel. The Mobile Station (MS) that enters the cell receives broadcast messages to obtain the SI of the cell. In this way, the network in the mobile communication system exercises general control over all users in the cell.

A Wideband Code Division Multiple Access (WCDMA) system is one type of cellular communication system. In a WCDMA system, the SI sent on the broadcast channel includes: System Information Block (SIB), Master Information Block (MIB), and Scheduling information Block (SB). The SIB falls into many types, each of which is adapted to notify all users in a cell of core network information, registration area information, public channel information, and neighboring cell information. The MIB includes information about the whole network and control information about the SIB and can include, for example, an indication about whether the corresponding SIB has changed.

Long Term Evolution (LTE) is a next-generation radio communication standard currently being developed by the 3^{rd} Generation Partnership Project (3GPP) organization. Compared with other communication systems, the LTE system provides a higher spectrum utilization ratio, a higher transmission speed, and a lower transmission delay. In the existing system message design, depending on different repetition periods, the SIB is included in different SI. The SI is a Radio Resource Control (RRC) message that carries at least one SIB. The SI is sent on the radio frame periodically. Each SIB includes a series of relevant SI parameters.

As shown in FIG. 1, the current standard protocol stipulates that SI-x falls into four types: SI-1, SI-2, SI-3, and SI-4. With further development of the standard, more SI may be introduced into the standard. According to the existing protocol, it is assumed that four SI-x periods are 80 ms, 160 ms, 320 ms, and 640 ms respectively. The network schedules different SI-x according to different periods. The position of SI-x depends on the System Frame Number (SFN) and the SI-x period (namely, N-x). The position of SI-x may be determined through SFN MOD N-x, for example, the position of SI-2 is: SFN MOD N-2=0, where N-2 is the period corresponding to SI-2. MOD refers to modulo operation.

In the process of developing the present invention, the inventor finds at least the following defects in the prior art:

In the prior art, on a specific SFN, for example, on SFN=64 in FIG. 1, namely, if SFN MOD 64=0, SFN MOD N=0 is applicable to all SI-x's. In this specific radio frame, SI-1, SI-2, SI-3, and SI-4 are sent sequentially on the sub-frames. Therefore, the network sends all SI-x's sequentially, and the network load is too great at such times. This problem is especially noticeable in a narrowband system. For example, in a 1.25 Mhz narrowband system, if the system messages are sent on sequential subframes, the system load increases drastically. Meanwhile, the priority of system messages is generally higher than the priority of other user data. When the network invokes such information preferentially, it is extraordinarily difficult to schedule other user data for transmission at such time, thus reducing the system scheduling efficiency and affecting the user satisfaction.

### SUMMARY

A method and a system for scheduling SI in a radio communication system are disclosed in an embodiment of the present invention to overcome excessive system load caused by improper SI scheduling at certain times in the prior art.

Such objectives are fulfilled through the following technical solution:

A method for scheduling SI in a radio communication system is disclosed in an embodiment of the present invention. The method includes:

determining an SFN for a radio frame;

setting at least two SIs and determining position of the at least two SIs according to the SFN of the radio frame; and

distributing the at least two SIs on different radio frames such that the SIs are sent at different times.

A system for scheduling SI is disclosed in an embodiment of the present invention. The system includes:

a determining apparatus, configured to determine an SFN for a radio frame, and

a setting apparatus, configured to set at least two SIs and determine position of the at least two SIs according to the SFN of the radio frame such that the entirety of each SI is distributed on different radio frames and sent at different times.

The system for scheduling SI under the present invention avoids excessive system load caused by sequentially sending of the Sis on subframes.

A terminal is disclosed in an embodiment of the present invention. The terminal includes:

an obtaining unit, configured to obtain network-side scheduling information;

a determining unit, configured to determine position of radio frames of SIs according to the scheduling information; and

a receiving unit, configured to receive the SIs according to position of the radio frames of the SIs, wherein the SIs are set to be distributed on the radio frames at different times.

Compared with the prior art, the embodiments of the present invention send all the SI onto the radio frames discretely at different times, optimize scheduling of SIs, avoid excessive network load caused by all SI being sent at any one time, and improve the efficiency of scheduling user data.

### BRIEF DESCRIPTION OF THE DRAWINGS

FIG. 1 shows a structure of scheduling SI in the prior art;

FIG. 2 shows a method for scheduling SI according to a first embodiment of the present invention;

FIG. 3 shows a method for scheduling SI according to a second embodiment of the present invention;

FIG. 4 shows a method for scheduling SI according to a third embodiment of the present invention;

FIG. 5 shows a method for scheduling SI according to a fourth embodiment of the present invention;

FIG. 6 shows a method for scheduling SI according to a fifth embodiment of the present invention;

FIG. 7 shows a method for scheduling SI according to a sixth embodiment of the present invention;

FIG. 8 shows a method for scheduling SI according to a seventh embodiment of the present invention;

FIG. 9 shows a structure of a system for scheduling SI according to an embodiment of the present invention; and

FIG. 10 shows a structure of a UE according to an embodiment of the present invention.

### DETAILED DESCRIPTION

In order to make the technical solution, objectives and merits of the present invention more clear, the present invention is hereinafter described in detail by reference to the accompanying drawings and preferred embodiments.

The SI scheduling method in a radio communication system under the present invention may optimize scheduling of SI, thereby avoiding excessive network load caused by all SI sent at any one time, and improving the efficiency of scheduling user data. The radio communication systems mentioned herein include: WCDMA (UMTS) systems, LTE systems and subsequent evolved systems. The description herein takes the LTE system as an example, but the radio communication systems under the present invention are not limited to the LTE system.

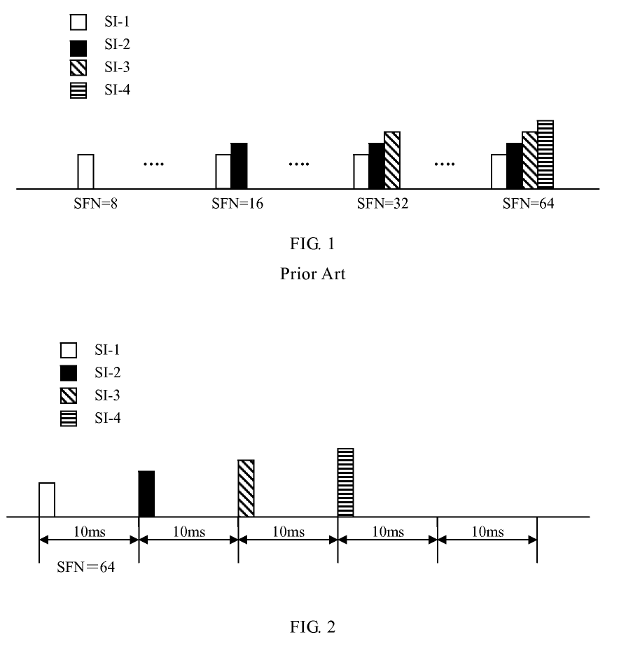

FIG. 2 shows a first embodiment of the present invention. The SI scheduling method under the present invention includes: determining an SFN; setting the SI-x in the system and the corresponding repetition period “N-x”, where x is a natural number for distinguishing SI and the period corresponding to the SI. In this embodiment, SI falls into four types: SI-1, SI-2, SI-3, and SI-4. It should be noted that the present invention is not limited to the four types. The SI in the system may fall into more types, such as six types, and so on. The SI scheduling method under the present invention further includes: keeping the relative position of SI-1 unchanged (namely, still setting SI-1 to be SFN MOD N-1=0, where N-1 is the repetition period corresponding to SI-1), moving the positions of SI-2, SI-3, and SI-4 as against SI-1 backward to some extent so that such SI-x's can be distributed onto different radio frames discontinuously for sending; and determining the position of the sub-frame of each SI-x according to SFN MOD N-x, thus accomplishing scheduling of the SI. The position of the radio frame of SI-x may be stipulated in the protocol, or may be preset, or may be indicated through a special signaling. The relevant scheduling information is notified to the UE, so that the UE can receive the corresponding information according to the specific scheduling information. The scheduling information includes: SI-x type, period N-x corresponding to SI-x, window size, gap, or frame offset, or any combination thereof.

As shown in FIG. 1, for example, it is appropriate to move the SI-2 position backward by one radio frame as against the SI-1 position, namely, set SI-2 onto SFN MOD 16=1, move SI-3 backward by two radio frames, namely, set SI-3 onto SFN MOD 32=2, and move SI-4 backward by three radio frames, namely, set SI-4 onto SFN MOD 64=3. In this way, the SI and its specific position are set so that the SI-1, SI-2, SI-3, and SI-4 can be distributed onto the radio frame discretely. Therefore, at a specific time, the network needs to send only one SI, without the need of sending SI-1, SI-2, SI-3, and SI-4 sequentially on the sub-frames like the practice in the prior art. Therefore, the network load is reduced and the efficiency of network scheduling is improved greatly. Meanwhile, the SI is sent out shortly, thus minimizing the impact onto other users and improving the user experience. Especially for a narrowband system, the gain is noticeable.

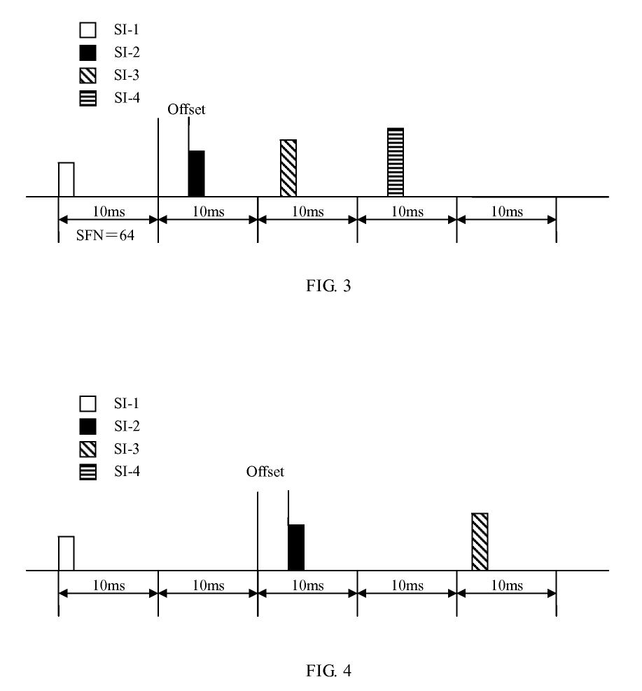

FIG. 3 shows a second embodiment of the present invention. Similar to the first embodiment, the SI scheduling method in the second embodiment of the present invention moves the position of SI-2, SI-3, and SI-4 backward to some extent as against SI-1, so that the SI can be distributed onto different radio frames discretely. The second embodiment differs from the first embodiment in that: The position of the radio frame of SI-x is indicated by frame offset. That is, the SFN is determined and the position of the subframe of the SI may be determined through the determined SFN, and the time of the SI is determined through the offset. Likewise, the specific system scheduling information and the specific scheduling method are stipulated through a protocol, or the UE is notified through a special signaling, so that the UE can receive the corresponding information according to the specific scheduling information.

FIG. 4 shows a third embodiment of the present invention. Similar to the first embodiment, the SI scheduling method in the third embodiment of the present invention moves the position of SI-2, SI-3, and SI-4 backward to some extent, so that the SI can be distributed onto different radio frames discretely. In this embodiment, SI-2 moves backward by two radio frames, namely, SI-2 is located on SFN MOD 16=2; SI-3 moves backward by four radio frames, namely, SI-3 is located on SFN MOD 32=4; and SI-4 moves backward by several frames, namely, SI-4 is located on SFN MOD 64=6. Likewise, after the SFN is determined, the pointer position of the SI may be stipulated in the protocol, or preset, or indicated through a special signaling. For example, the position is indicated through SI-1, obtained directly through SFN MOD, or, in the second embodiment, indicated by offset.

In the SI scheduling method disclosed in a fourth embodiment, at the time of sending SI-x, SI-x may need to be retransmitted for certain times in order to improve the reliability of receiving the SI. Like the first embodiment, the method in the fourth embodiment includes: determining the SFN, setting SI-x in the system and the corresponding period N-x, setting the number of times of retransmitting each SI, and determining the window size of SI and the gap between two adjacent SI windows according to the SFN, the SI-x, the corresponding period N-x, and the retransmission count.

The window size and the gap value of the SI may be determined according to the system bandwidth required. The system bandwidth falls into many types: 1.25 MHz, 5 MHz, 10 MHz, 20 MHz, and so on. For example, as shown in Table 1, the value of the sum of the window size and the gap may vary with the system bandwidth required.

TABLE 1

| Bandwidth | Window Size + gap |
|---|---|
| 1.25 MHz | 20 ms |
| 2.5 MHz | 20 ms |
| 5 MHz | 10 ms |
| 10 MHz | 5 ms |
| 15 MHz | 5 ms |
| 20 MHz | 5 ms |

Optionally, as shown in Table 2, the value of the sum of the window size and the gap are set to be the same (for example, 20 ms) between different system bandwidths, and the values of the window size and the gap are adjusted properly according to the system bandwidth required. For example, for a 1.25 MHz narrowband system, if SI falls into: SI-1, SI-2, SI-3, and SI-4, the window size may be set to 20 ms, and the gap may be set to 0 ms. In this way, the SI-x's may be distributed within 80 ms more averagely, thus avoiding impact on sending of the downlink service. For the system with higher bandwidth (20 MHz), the SI-x's may be distributed in one or several radio frames, thus shortening the waiting time of the UE and saving the power consumption of the UE.

TABLE 2

| | Window size + gap = fixed value (for example, 20 ms); | |
|---|---|---|
| | the window size and the gap may be adjusted to | |
| | shorten the search time of UE (it is not | |
| | necessary to search for SI during the gap) | |
| Bandwidth | Window size | Gap |
| 1.25 MHz | 20 ms | 0 ms |
| 2.5 MHz | 20 ms | 0 ms |
| 5 MHz | 15 ms | 5 ms |
| 10 MHz | 10 ms | 10 ms |
| 15 MHz | 5 ms | 15 ms |
| 20 MHz | 5 ms | 15 ms |

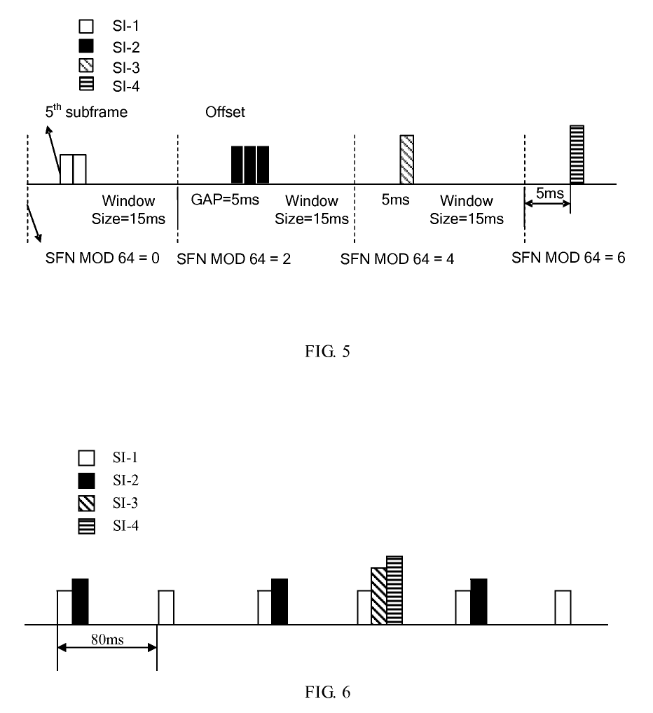

FIG. 5 shows a system with a bandwidth of 5 MHz. Supposing that there are four types of SI, the four types of SI occupy 20 ms*4=80 ms. It is assumed that the window size of the SI is 15 ms, and the gap value is 5 ms. When the SFN-x MOD 64=0, SI-1 occupies the 20 ms subsequent to the SFN MOD 64=0 time, SI-2 occupies the 20 ms subsequent to SI-1, SI-3 occupies the 20 ms subsequent to SI-2, and SI-4 occupies the 20 ms subsequent to SI-3. In other words, the four SI-x's are arranged sequentially, and each SI-x is subsequent to the previous SI-x. Therefore, the SI-x's may be distributed discontinuously, and may be sent out shortly. The impact on scheduling of other user data is reduced, and the user experience is improved. The system does not need to send plenty of data at the same moment, thus reducing the network load effectively. Similar to that in the first, second and third embodiments, the scheduling method according to this embodiment can be stipulated in the protocol, or be preset, or be notified to the UE through a special signaling, for example, notified to the UE through SI-1. So long as the UE reads SI-1 at SFN MOD 64=0, the UE may obtain the delivered scheduling method through SI-1, and determine the SFN of each SI-x. Optionally, the relevant scheduling information may be notified to the UE through other signaling.

It should be noted that, in this embodiment, the subframe delivered by each SI is not detailed, and the configuration solution applicable to the scenario that requires repeated delivery is not detailed. The standard protocol may stipulate multiple configuration methods. The specific configuration method to be applied may be indicated to the UE through a special signaling, for example, through SI-1. The position of the radio frame of the SI may be determined through an offset, window size, or gap, which is flexibly configurable. Besides, the parameters in this embodiment may be configured flexibly according to the system bandwidth, and are not necessarily restricted strictly like Table 2. For example, for a system with a 1.25 MHz bandwidth, the network may be allowed to configure the system in a window size in the SI according to the service conditions, without the need of notifying the UE. For example, if the SI does not occur sequentially within a window size, the UE performs continuous decoding in the window size and receives the SI. For another example, for a system with a bandwidth of 20 MHz, the SI may be set to be sent at the fifth subframe by default, and, if necessary, sent repeatedly in the subsequent sub-frames.

FIG. 6 shows the SI scheduling method in the fifth embodiment of the present invention. This embodiment is similar to the first embodiment, and differs in that: The SI scheduling method in this embodiment keeps the relevant positions between SI-1 and SI-2 unchanged, and moves the positions of SI-3 and SI-4 backward to some extent as against SI-1, so that the SI-1, SI-2, SI-3, and SI-4 cannot be distributed onto different radio frames continuously at the same time. Specifically, SI-2 moves backward by eight radio frames, namely, moves onto SFN MOD 32=8. SI-4 moves backward by eight radio frames, namely, moves onto SFN MOD 64=8. After the SFN is determined, the position of the radio frame of SI-x may be stipulated in the protocol, or may be indicated to the UE through a special signaling (such as SI-1 or another signaling), so that the UE can determine the position of each SI and receive the corresponding information according to the specific scheduling information.

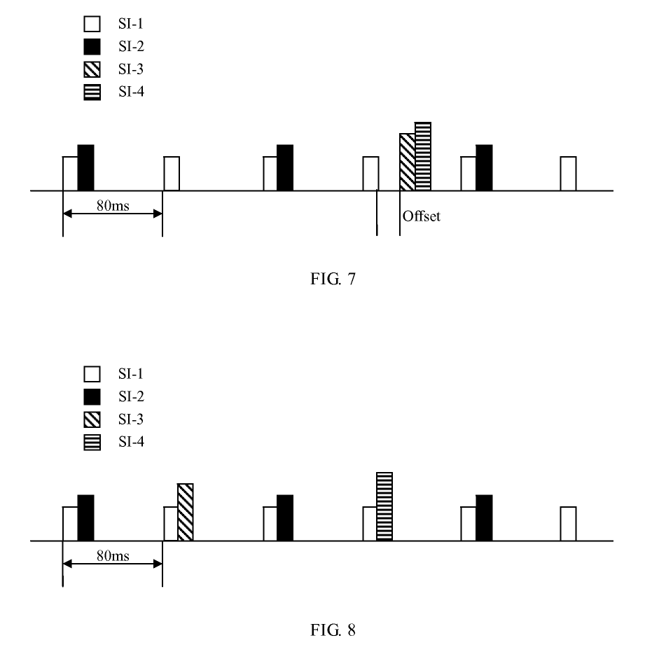

FIG. 7 shows the sixth embodiment of the present invention. Similar to the fifth embodiment, the SI scheduling method in the sixth embodiment of the present invention moves the position of SI-3 and SI-4 backward to some extent so that the SI-x's can be distributed onto different radio frames discretely. The position of the radio frame of SI-x is indicated through offset. That is, the SFN is determined and the position of the radio frame of the SI-x may be determined through the determined SFN, and the time of the SI-x is determined through the offset. Likewise, the specific system scheduling information and the specific scheduling method are stipulated through a protocol, or the UE is notified through a special signaling (for example, through SI-1 or another signaling) so that the UE can receive the corresponding information according to the specific scheduling information.

FIG. 8 shows the seventh embodiment of the present invention. Similar to that in the fifth embodiment, the SI scheduling method in the seventh embodiment of the present invention keeps the relevant position between SI-1 and SI-2 unchanged, moves the positions of SI-3 and SI-4 backward to some extent so that the SI-1, SI-2, SI-3, and SI-4 cannot be distributed onto different radio frames continuously at the same time. Specifically, SI-2 moves backward by eight radio frames, namely, moves onto SFN MOD 32=8; and SI-4 moves backward by 16 radio frames, namely, moves onto SFN MOD 64=16.

It should be noted that in the SI scheduling method disclosed in this embodiment, for the relevant position of SI and in the previous embodiments, the distance of moving SI-x backward as against SI-1 is not restricted strictly. So long as the SI-x's are distributed on the radio frame discretely at any time, the excessive system load and the low efficiency of data scheduling caused by sequential distribution of SI-x on sub-frames in the prior art can be overcome. Besides, as regards the specific method of scheduling SI, the position of SI-x in the radio frame may be determined by setting the position of SI-x directly, or by determining the position of the frame of SI-x first, and then calculating the offset, or calculating both the offset and the gap; or the position of SI-x is indicated by other means. That is, those skilled in the art may make variations and modifications to any of the foregoing embodiments without making any creative effort.

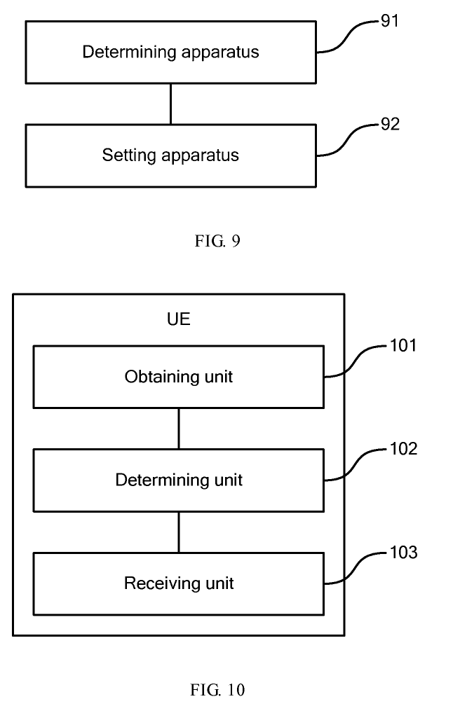

A system for scheduling SI is disclosed in an embodiment of the present invention. The system implements the steps of the method in the foregoing embodiments. As shown in FIG. 9, the system includes:

a determining apparatus 91, configured to determine the SFN; and

a setting apparatus 92, configured to set SI, determine the position of the SI according to the SFN, therefore all SI is distributed on the radio frames at different times for sending.

The system for scheduling SI under the present invention avoids excessive system load caused by continuous sending of the SI.

A UE is disclosed in an embodiment of the present invention to implement the steps of the terminal described in the foregoing embodiments. As shown in FIG. 10, the UE includes:

an obtaining unit 101, configured to obtain network-side scheduling information;

a determining unit 102, configured to determine the position of the radio frame of the SI according to the scheduling information; and

a receiving unit 103, configured to receive the corresponding SI according to the position of the radio frame of the SI.

The scheduling information includes: SI-x type, period N-x corresponding to SI-x, retransmission count of SI-x, window size of SI-x, frame offset, or gap, or any combination thereof.

A computer-readable medium is disclosed in an embodiment of the present invention to store a series of programs for performing the steps in the foregoing method embodiment.

After reading the foregoing embodiments, those skilled in the art are clearly aware that the technical solution under the present invention may be implemented through hardware, or through software in addition to a necessary universal hardware platform. Therefore, the technical solution under the present invention may be embodied as a software product. The software product may be stored in a non-volatile storage medium (such as CD-ROM, USB flash disk, or mobile hard disk), and may include several instructions that enable a computer device (such as personal computer, server, or network device) to perform the methods provided in the embodiments of the present invention.

Although the invention has been described through several embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the claims or their equivalents.

What is claimed is:

1. A method for scheduling System Information (SI) in a radio communication system, the method comprising:
determining a System Frame Number (SFN) for a radio frame;
setting at least two SIs and determining position of the at least two SIs according to the SFN of the radio frame; and
distributing the at least two SIs on different radio frames such that the SIs are sent at different times.

2. The method according to claim 1, wherein setting the SI comprises: setting SI type SI-x and repetition period N-x corresponding to the SI type, wherein x is a natural number.

3. The method according to claim 2, wherein determining position of the at least two SIs according to the SFN of the radio frame comprises: determining radio frames position of each SI-x according to SFN MOD N-x.

4. The method according to claim 3, wherein the method further comprises: determining position of each SI-x according to position of radio frame of the SI-x, frame offset, window size of the SI-x, gap, or any combination thereof.

5. The method according to claim 4, wherein the method further comprises notifying a UE of a scheduling information, thereby enabling the UE to receive corresponding information according to the scheduling information.

6. The method according to claim 5, wherein the scheduling information comprises SI-x type, period N-x corresponding to the SI-x, retransmission count of the SI-x, window size of the SI-x, gap, or frame offset, or any combination thereof.

7. The method according to claim 1, wherein the method further comprises notifying a UE of a scheduling information, thereby enabling the UE to receive corresponding information according to the scheduling information.

8. The method according to claim 7, wherein the scheduling information comprises SI-x type, period N-x corresponding to the SI-x, retransmission count of the SI-x, window size of the SI-x, gap, or frame offset, or any combination thereof.

9. A system for scheduling System Information (SI), the system comprising:
a determining apparatus, configured to determine a System Frame Number (SFN) for a radio frame, and
a setting apparatus, configured to set at least two SIs and determine position of the at least two SIs according to the SFN of the radio frame so that all the SI is distributed on different radio frames and sent at different times.

10. The system according to claim 9, wherein the setting apparatus is further configured to determine position of each SI-x according to position of radio frame of the SI-x, offset, window size, gap, or any combination thereof.

11. The system according to claim 9, wherein the system further comprises an apparatus configured to notify a UE of scheduling information, thereby enabling the UE to receive corresponding information according to the scheduling information.

12. The system according to claim 11, wherein the scheduling information comprises SI-x type, period N-x corresponding to the SI-x, retransmission count of the SI-x, window size of the SI-x, gap, or frame offset, or any combination thereof.

13. A terminal, comprising:
an obtaining unit, configured to obtain network-side scheduling information;
a determining unit, configured to determine position of radio frames of System Informations, SIs, according to the scheduling information; and
a receiving unit, configured to receive the SIs according to position of the radio frames of the SIs, wherein the SIs are set to be distributed on the radio frames at different times.

14. The terminal according to claim 13, wherein the scheduling information comprises SI-x type, period N-x corresponding to the SI-x, retransmission count of the SI-x, window size of the SI-x, gap, or frame offset, or any combination thereof.
